(19) United States
(12) Patent Application Publication
(10) Pub. No.: US 2007/0036194 A1
(43) Pub. Date: Feb. 15, 2007

(54) Excimer-lamp pumped semiconductor laser

(76) Inventors: Sergei V. Govorkov, Mountain View, CA (US); Luis A. Spinelli, Sunnyvale, CA (US); R. Russel Austin, Keswick (GB)

Correspondence Address: STALLMAN & POLLOCK LLP, 353 SACRAMENTO STREET, SUITE 2200, SAN FRANCISCO, CA, 94111, US

(21) Appl. No.: 11/203,734

(22) Filed: Aug. 15, 2005

(51) Int. Cl. H01S 3/22; H01S 3/091; H01S 3/09

(52) U.S. Cl. 372/57; 372/70; 372/74

(57) ABSTRACT

In an optically pumped semiconductor laser including a semiconductor laser heterostructure, energy of high-energy electrons of an electron beam is converted by excimer formation and dissociation in a gas into ultraviolet (UV) radiation. The ultraviolet radiation is used to optically pump the heterostructure. Materials of the heterostructure may include II-VI compounds, oxides, or diamond. Both surface-emitting and edge-emitting heterostructures may be optically pumped by the UV radiation.

### TECHNICAL FIELD OF THE INVENTION

The present invention relates to in general to semiconductor lasers. The invention relates in particular to semiconductor lasers emitting light in the violet and ultraviolet (UV) region of the electromagnetic spectrum.

### DISCUSSION OF BACKGROUND ART

Among commercially available semiconductor lasers the shortest wavelengths are emitted by aluminum indium gallium nitride (AlInGaN) diode-lasers. These semiconductor lasers emit at wavelengths of about 400 nanometers (nm). There are novel material systems, however, such as semiconductor materials in the II-VI material group, oxides, for example zinc oxide (ZnO), and diamond, that have a sufficiently wide bandgap to emit in the UV optical range.

Practically, pumping a semiconductor laser made from these novel material systems is presently limited to electrical pumping, either by electron-hole injection or by an electron beam. In order to effect electron-hole injection pumping the semiconductor laser must be configured as a diode-laser. This requires creating a p-n junction with p- and n-doped layers. Such doped layers are not readily available in the above-discussed novel material systems.

Electron beam (e-beam) pumping has a disadvantage that roughly 70% of multi-keV (kilo electron-volt) electron energy is necessarily converted into heat in the course of a multi-step electron-energy to optical-energy conversion process. This is described in a paper Power Efficiency and Quantum efficiencies of electron-Beam Pumped Lasers, Claude A. Klein, IEEE J. Quant. Electr., v.QE-4, no. 4, April 1968, pp. 186-194. High electron energy is required to penetrate at least a few micrometers (μm) into semiconductor material. A result is that e-beam pumped semiconductor lasers have high thresholds and low efficiency, and have to be operated in pulsed or scanning mode to dissipate excessive heat.

It would be possible to optically pump lasers made from wide-bandgap materials with light from a pump-laser emitting radiation at a shorter wavelength than that emitted by the semiconductor laser. Such lasers would include lasers that generate UV radiation by converting fundamental-wavelength radiation of gas lasers, dye, lasers or solid-state lasers at visible and longer wavelengths into UV radiation by frequency conversion in one or more optically nonlinear crystals. These lasers, however, are expensive and complex, often relatively inefficient, and are relatively bulky compared with a semiconductor laser.

There is a need for a method of pumping lasers made from wide-bandgap materials that does not have the above-discussed shortcomings of electron-hole injection, e-beam pumping, and pumping with conventional UV-emitting lasers.

### SUMMARY OF THE INVENTION

The present invention is directed to providing an optically pumped semiconductor laser including a semiconductor heterostructure emitting radiation at wavelength in the violet or ultraviolet region of the electromagnetic spectrum. In one aspect of the invention a method of operating the semiconductor laser includes converting electron energy to optical radiation in an excimer-forming gas, and optically pumping the semiconductor heterostructure with the optical radiation.

In another aspect of the invention, a laser in accordance with the invention comprises first and second enclosures having an electron-permeable membrane therebetween. The first enclosure is under vacuum, and the second enclosure contains an excimer-forming gas. An electron gun is located in the first enclosure and arranged to generate an electron beam and direct the electron beam through the membrane into the excimer-forming gas thereby generating optical radiation. The semiconductor heterostructure is arranged to be optically pumped by the optical radiation.

In preferred embodiments of the invention, the excimer-forming gas includes one of a first group of elements, one of a second group of elements, or a mixture of one of the first group of elements and one of the second group of elements. The first group of elements consists of helium (He), neon (Ne), argon (Ar), krypton (Kr), and xenon (Xe). The second group of elements consists of fluorine (F), chlorine (Cl), bromine (Br), and iodine (I). The optical radiation generated in the excimer reaction has a wavelength between about 60 nm and 353 nm depending on the composition of the excimer-forming gas. Materials of the heterostructure have a bandgap of about 3 electron-volts (eV) or greater.

### BRIEF DESCRIPTION OF THE DRAWINGS

The accompanying drawings, which are incorporated in and constitute a part of the specification, schematically illustrate a preferred embodiment of the present invention, and together with the general description given above and the detailed description of the preferred embodiment given below, serve to explain the principles of the present invention.

FIG. 1A & FIG. 1B are respectively front and side elevation views, partly in cross-section, schematically illustrating one preferred embodiment of an optically pumped, edge-emitting semiconductor laser in accordance with the present invention, including two enclosures, one under vacuum and one containing an excimer-forming gas, the two enclosures being separated by an electron-transparent membrane, the vacuum enclosure having an electron gun therein directing electrons through the membrane into the other enclosure and generating UV radiation in the excimer-forming gas, and an edge-emitting semiconductor laser heterostructure being located in the excimer-forming gas enclosure and optically pumped by the UV radiation.

FIG. 2A & FIG. 2B are respectively front and side elevation views, partly in cross-section, schematically illustrating another preferred embodiment of an optically pumped, edge-emitting semiconductor laser in accordance with the present invention similar to the laser of FIGS. 1A and 1B, but further including a UV light-guide for concentrating the UV radiation on the semiconductor heterostructure.

FIG. 3A & FIG. 3B are respectively front and side elevation views, partly in cross-section, schematically illustrating yet another preferred embodiment of an optically pumped, edge-emitting semiconductor laser in accordance with the present invention similar to the laser of FIGS. 2A and 2B, but wherein the heterostructure is outside of the excimer-forming gas enclosure.

FIG. 4 is a front elevation view, partly in cross-section, schematically illustrating still another embodiment of an optically pumped, edge-emitting semiconductor laser in accordance with the present invention, similar to the laser of FIGS. 2A and 2B, but wherein the UV light-guide is replaced by cylindrical focusing optics for concentrating the UV radiation on the semiconductor heterostructure.

FIG. 5 is a front elevation view, partly in cross-section, schematically illustrating still yet another embodiment of an optically pumped, edge-emitting semiconductor laser in accordance with the present invention, similar to the laser of FIGS. 2 and 2A, but wherein there is a plurality of elongated, spaced-apart parallel membranes aligned with a corresponding plurality of elongated, spaced-apart, parallel light-guides, and an elongated electron beam from the electron beam gun is scanned sequentially from membrane to membrane such that parallel strips of the heterostructure are sequentially optically pumped.

FIG. 5A is a three-dimensional view, schematically illustrating details of the electron beam, parallel membranes, light-guides, and heterostructure of FIG. 5.

FIG. 6 is an elevation view partly in cross-section, schematically illustrating one embodiment of an optically pumped, surface-emitting semiconductor laser in accordance with the present invention similar to the laser of FIG. 4, but wherein the semiconductor heterostructure is a surface-emitting heterostructure including a mirror-structure and a gain-structure with the mirror-structure forming a laser resonator with a concave mirror and the gain-structure being in the resonator so formed.

FIG. 6A is a three-dimensional view schematically illustrating details of the arrangement of the electron beam, membrane, and surface-emitting heterostructure of FIG. 6.

FIG. 7 is an elevation view, partly in cross-section, schematically illustrating another embodiment of an optically pumped, surface-emitting semiconductor laser in accordance with the present invention, similar to the laser of FIGS. 1A and 1B but wherein there is no semiconductor heterostructure in the excimer-forming gas enclosure, and that enclosure includes two mirrors forming a first laser-resonator for amplifying the UV radiation as a UV laser beam, and wherein there is a surface-emitting heterostructure located outside of the excimer-forming gas enclosure with the mirror-structure of the heterostructure forming a second laser-resonator with a concave mirror, and with the gain-structure being in the resonator so formed and optically pumped by UV laser radiation from the first laser-resonator.

FIG. 8 is an elevation view, partly in cross-section, schematically illustrating yet another embodiment of an optically pumped, surface-emitting semiconductor laser in accordance with the present invention, similar to the laser of FIG. 7, but wherein the surface-emitting heterostructure is located inside the resonator and the first and second resonators are replaced with a common resonator formed between the mirror-structure of the heterostructure and a concave mirror.

### DETAILED DESCRIPTION OF THE INVENTION

Optically pumped semiconductor lasers in accordance with the present invention utilize the principle of an excimer lamp to convert electron energy into optical radiation, particularly UV radiation. The term UV radiation, here, refers to radiation having a wavelength of about 425 nm or less. That UV radiation is then used to pump a semiconductor heterostructure for generating UV or violet laser radiation. An advantage of an excimer lamp over an excimer laser or a frequency-converted solid state or gas laser is that the excimer lamp can be simple and compact by comparison, and can also be remarkably efficient. An excimer lamp converts energy of high energy electrons, for example having an energy between about 10-25 keV, into UV radiation. The efficiency of such conversion can be as high as 87% for a single-species excimer such as a xenon (Xe) excimer (Xe₂*), which emits radiation at a wavelength of about 172 nm. This wavelength corresponds to a photon energy of about 7 eV, which is a relatively close match to the emission-photon energy of above-discussed wide-bandgap materials. By way of example, the bandgap of diamond is 5.5 eV, that of aluminum nitride (AlN) is about 6 eV, and that of magnesium sulfide (MgS) is 4.8 eV. Accordingly, this UV radiation can be used to pump the inventive lasers built on these materials. Because of the close match between the optical pump photon-energy and the emission photon-energy of the material being optically pumped, a minimal amount of heat is generated at the optical pumping stage. Accordingly optical pumping can be more efficient, and lasing threshold can be reduced compared with prior-art electrically pumped wide-bandgap lasers. Further, as will be appreciated from the detailed description of the present invention provided hereinbelow, heat released at the stage of converting e-beam energy to UV radiation energy can be prevented from entering the semiconductor gain medium.

The term “excimer” as used in this description and the appended claims refers to a short-lived molecule that bonds two molecules when in an electronic excited state. The excitation, here, is provided by impact with energetic inert gas molecules that have been energized by high energy electrons. The molecules here are gaseous molecules. The lifetime of the excimer is usually on the order of several nanoseconds, after which the components of the molecular excimer strongly disassociate and repel, returning the components to the ground state and giving up excited-state energy as UV radiation.

An excimer can be created by an excited-state interaction between two molecules of the same element or by an interaction between two molecules each of a different element. A first group of elements that can provide excimer interaction when energized consists of helium, neon, argon, krypton, and xenon. A gas including any one of these elements can produce an excimer. Such excimers can be referred to as single-element excimers and can be correspondingly designated He₂* (60), Ne₂* (80), Ar₂* (128), Kr₂* (145), and Xe₂* (172). Numbers in parentheses indicate the peak-emission wavelength in nanometers. This group provides the most efficient conversion of electron energy to optical energy with the highest being about 87% for Xe₂* as discussed above.

A second group of elements that can provide single-element excimers consists of fluorine, chlorine, bromine, and iodine, providing excimers F₂* (157), Cl₂* (258), Br₂* (290), and I₂* (343), respectively. Electron-to-optical energy conversion efficiency for these excimers is about 30% or less.

In a gas mixture including one element from the first group and one element from the second group a two-element excimer can be created. Such two-element excimers include NeF* (108), ArF* (193), KrF* (248), XeF* (353), ArCl* (175), KrCl* (222), XeCl* (308), KrBr* (206), XeBr* (282), KrI* (185) and XeI* (253). Electron-to-optical energy conversion efficiency for these excimers is about 30% or less.

An excimer H* (121.6) can be provided by electron interaction with an excimer-forming gas containing hydrogen, and an excimer N₂* (337) can be created by electron interaction an excimer-forming gas including nitrogen. Conversion efficiency for these elements, however, is less than about 10%.

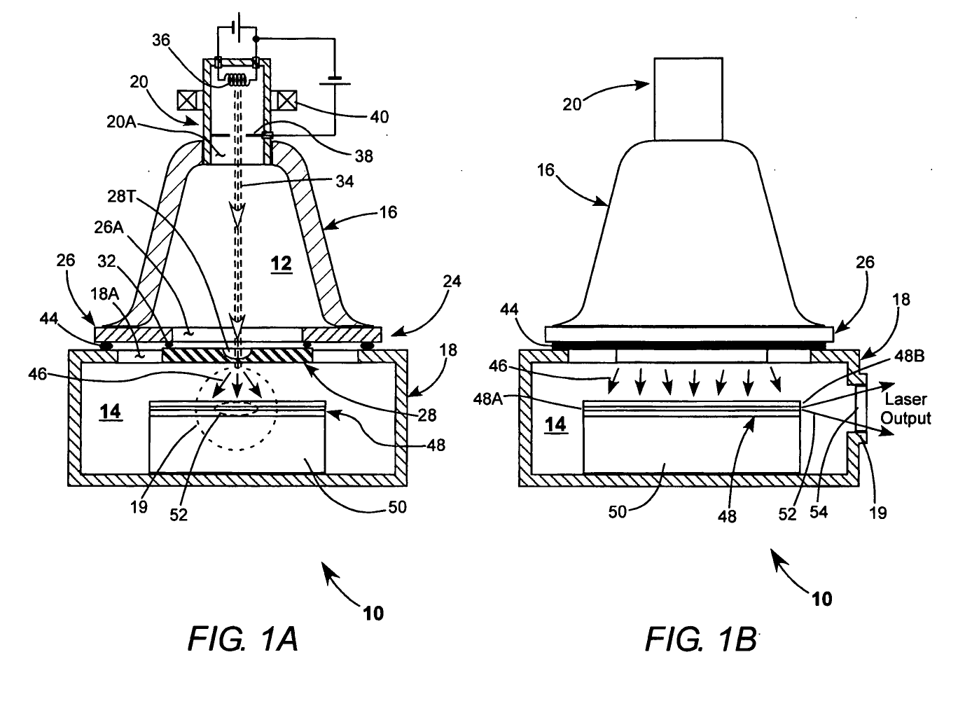

Turning now to the drawings, wherein like components are designated by like reference numerals, FIG. 1A and FIG. 1B schematically illustrate one preferred embodiment 10 of an optically pumped, edge-emitting semiconductor in accordance with the present invention. Laser 10 comprises two gas-tight enclosures 12 and 14 having a common boundary 24. Enclosure 12 is a vacuum enclosure including an open-ended bell-shaped vessel 16. Vessel 16 may be made from glass, ceramics, or metal or some combination of these.

An electron-beam gun (e-gun) 20 is sealed into one end of vessel 16. A flange 26 having an aperture 26A extending therethrough is sealed, here, by welding, to the opposite end of vessel 16. Flange 26, in this example, becomes part of the common boundary of enclosures 12 and 14. Enclosure 12 (boundary 24) is completed attaching over aperture 26A of flange 26 a plate 28, preferably of a very rigid ceramic such as silicon nitride (SiN_{X}), or aluminum nitride. Plate 28 may also be made of diamond. One preferred method of attaching plate 28 to the flange is by means of a solder seal 32. Flange 26 is preferably made from a material such as invar for matching the coefficient of the thermal expansion between the material of vessel 16 and plate 28.

The e-gun 20, in this example, provides an electron beam (e-beam) 34 by accelerating electrons from a heated filament 36 through an accelerating electrode 38. A focusing coil 40 is included as part of e-beam focusing and shaping (electron-lens) arrangements. The electron-lens arrangements are configured such that e-beam 34 is elongated in a direction perpendicular to the plane of FIG. 1A, i.e., parallel to the plane of FIG. 1B. It should be noted that only a simple electron lens arrangement is depicted in FIG. 1A, and other drawings referred to herein, for convenience of illustration. The design of e-gun electron lenses, including a plurality of electrostatic and magnetic components, for providing specific beam shapes is well known in the cathode-ray tube (CRT) art, and a knowledge thereof is not necessary for understanding principles of the present invention.

Plate 28 has a region 28T thereof thinned sufficiently to allow the passage of e-beam 34. This thinned region can be described as an electron-permeable or electron-transparent membrane. In a silicon nitride plate, a membrane thickness of about 300 nm over a width of about 1 mm can provide adequate electron transparency while still providing sufficient rigidity to support a pressure difference of about 2000 millibars (mbar) across the membrane.

Enclosure 14 includes a cylindrical vessel 18 having an open end 18A. The open end of the vessel is sealed to flange 26 of the common boundary assembly 24 by seal 44, thereby completing the enclosure. Enclosure 14 contains an excimer-forming gas (gas mixture) as described above. Usually about 99% of an excimer-forming gas is an inert gas with the remainder including the excimer-forming element or elements. Gas pressure is usually between about 1000 mbar and 2000 mbar. Excimer-forming gas mixtures in pressurized cylinders are commercially available from a number of suppliers. It is important that the purity of the excimer-forming gases is maintained to provide a useful operating lifetime (or period between maintenance intervals) of the laser. Accordingly, a metal seal is preferred for seal 44.

When e-gun 20 is operated, electron beam 34 is generated and directed onto membrane 28T. High energy electrons in the beam penetrate the membrane and interact with the excimer-forming gas, thereby generating UV radiation as described above. The UV radiation is designated by arrows 46 in FIGS. 1A and 1B. A particular advantage of this arrangement is that, unlike an excimer laser wherein an excimer-forming gas is energized by electrons of a gas-discharge created in the excimer-forming gas, the generation of e-beam 34 is independent of the excimer-forming gas.

The UV radiation generated can by concentrated as essentially a point source or line source, depending on how the electron beam is shaped by the electron lens arrangement of e-gun 20, or the membrane. By way of example the radiation can be confined to a volume extending between about 1 mm to 2 mm below membrane 28T. It is possible to generate UV having a brightness of about 1 milliwatt per square mm-steradian (mW/[mm² sr]) when operating electron gun 20 in a continuous (CW) mode, or a brightness of about 1000 mW/[mm² sr] when operating e-gun 20 in a pulsed mode. Generation efficiency depends on the particular excimer being created as discussed above.

Continuing with reference to FIGS. 1A and 1B, enclosure 14 contains a multilayer semiconductor heterostructure 48 supported on a substrate or heat sink 50. Heterostructure 48 is an edge-emitting heterostructure. By way of example, the structure could be a double-confinement heterostructure having an active region including one or more quantum well layers. The active region would be bounded by optical confinement layers and the structure of active and optical confinement layers bounded by electrical confinement layers. Such a heterostructure typically has a maximally reflecting coating at one end thereof (here, not shown, at end 48A) and a lower-reflecting coating (or even an antireflective coating) at opposite end thereof (here, not shown, at end 48B). These reflective coatings form a laser resonator. Edge-emitting semiconductor heterostructures are well-known in the art and a detailed description of such structures and growth thereof is not necessary for understanding principles of the present invention

In one example, material of the semiconductor layers of heterostructure can be from the II-VI group of materials, particularly MgS, BeSe, MgSe, ZnS and related compounds, for example ZnMgSSe. In another example, the materials can be from a material system based on metal nitrides, such as AlGaN and AlInGaN compounds. In yet another example, materials can be metal oxides such as ZnO, ZnMgO and related compounds. Diamond can also be employed as quantum-well layer in a heterostructure including such oxide materials. These examples of materials should not be construed as limiting the present invention.

Because of the relatively close proximity, for example between about 1 mm to 3 mm, of the heterostructure from the volume of the generated UV radiation, the UV radiation can be absorbed by the heterostructure and energizes (optically pumps) the heterostructure. When thus optically pumped, the heterostructure delivers laser radiation 52 having a wavelength longer than the wavelength of the UV radiation. This laser radiation is delivered through a window 54 located in a flange 19 included in vessel 18. Note that in FIG. 1A, radiation 52 is depicted in phantom and having the typical elliptical near-field mode shape of a wide-stripe edge-emitting semiconductor laser.

A disadvantage of above-described laser 10 is the relatively close proximity of the semiconductor heterostructure to the UV radiation volume. Because of this, heat generated in the process of the excimer conversion of electron-beam energy to UV radiation can heat the heterostructure and adversely affect the performance of the semiconductor laser. For this reason, the arrangement of laser 10 is best suited for use with single-element excimer reactions with elements from the above-described first group of elements. For these elements conversion efficiency is highest, and the heat generated, correspondingly, the lowest.

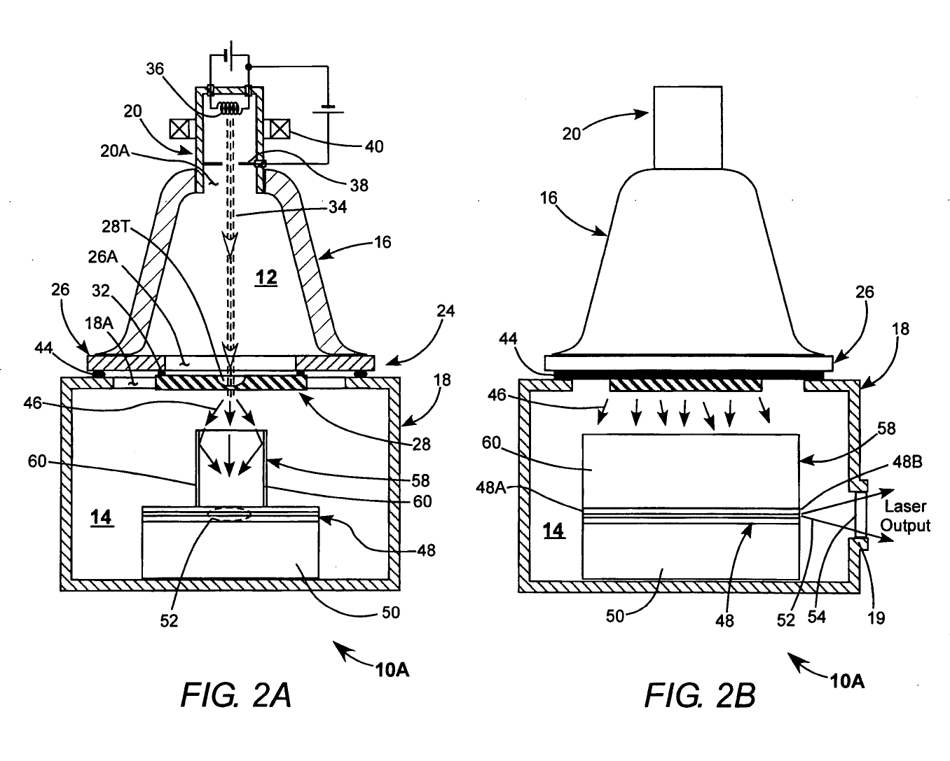

FIGS. 2A and 2B schematically illustrate another embodiment 10A of an optically pumped, edge-emitting semiconductor laser in accordance with the present invention. Laser 10A is similar to laser 10 but the heterostructure is further away from the UV radiation volume than is the case in laser 10. In laser 10A, an elongated light-guide 58 is in contact with the upper (exposed) surface of heterostructure 48. Light-guide 58 collects UV radiation 46 and directs the radiation into the heterostructure. In one preferred example, the light-guide has a width of between about 1 and 3 mm. The light-guide is preferably made from a material such calcium fluoride (CaF₂) or magnesium fluoride (MgF₂) having a high UV-transparency. Sides of the light-guide preferably have reflective coatings 60 thereon, for example, a silver, gold or aluminium coating, a dielectric multilayer coatings, or a metal coating with reflection-enhancing dielectric layers. Light-guide 58 not only allows the heterostructure to be distanced from the UV radiation volume, and accordingly heat generated therein, but can also serve as a heat-sink for extracting some of the heat that is generated as a result of optically pumping the heterostructure.

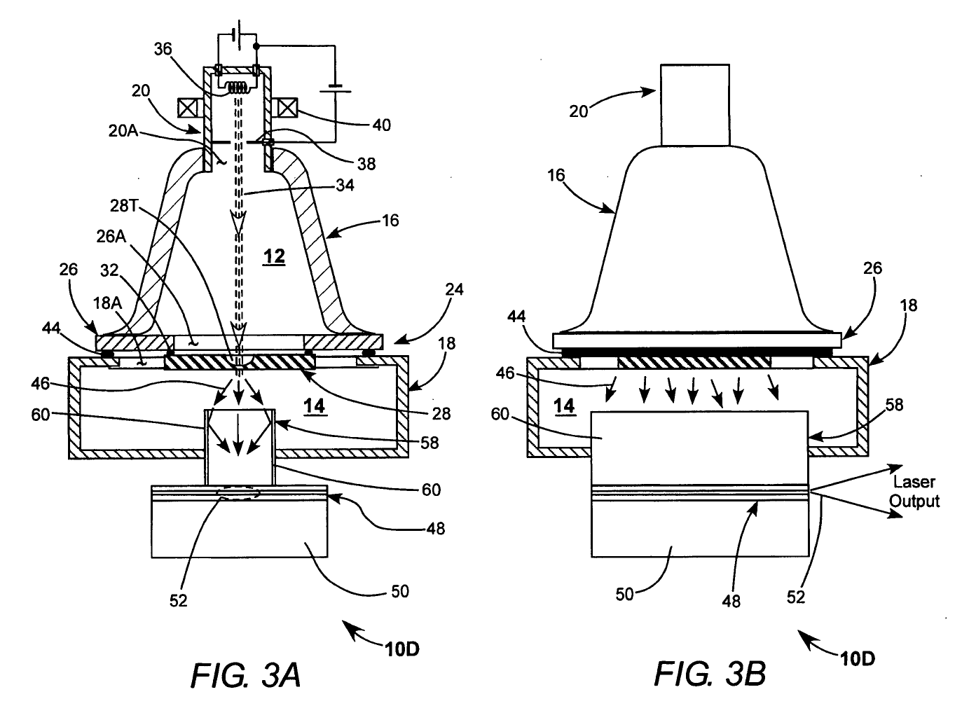

FIGS. 3A and 3B schematically illustrate another embodiment 10D of an optically pumped, edge-emitting semiconductor laser in accordance with the present invention. Laser 10D is similar to laser 10A except the heterostructure is outside of vessel 18. In laser 10D, light-guide 58 provides a window in vessel 18. As the heterostructure is outside of vessel 18, vessel 18 does not require a window for laser output.

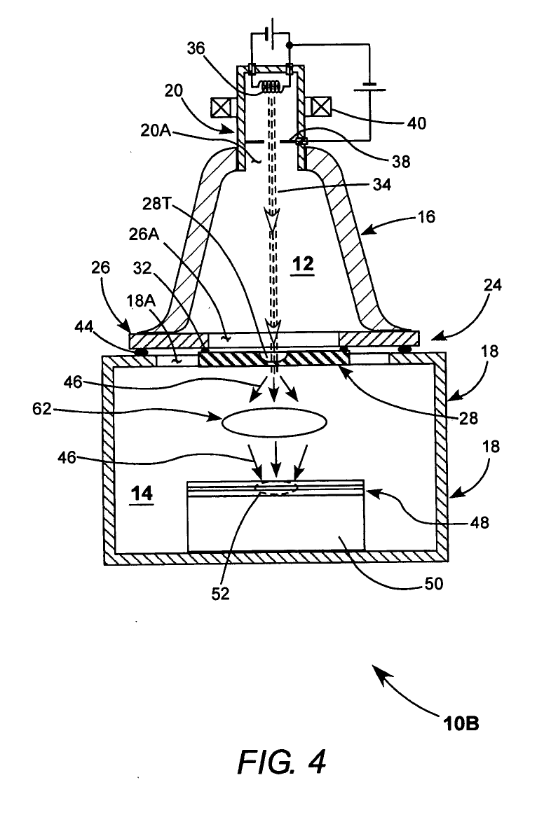

FIG. 4 schematically illustrates still another embodiment 10B of an optically pumped, edge-emitting semiconductor laser in accordance with the present invention in which the heterostructure is distanced from the UV radiation volume. Laser 10B is similar to laser 10A with an exception that light-guide 58 is replaced in laser 10B with collecting and focusing optics 62. This provides for distancing the heterostructure from the UV radiation volume and also provides for greater concentration of the UV radiation on the heterostructure than is possible with the light-guide.

Optics 62 is represented in FIG. 4 as a single optical element. The optics, which must project the UV radiation as a line of radiation on the heterostructure, may, however, comprise two or more elements. At least one such element would be cylindrical (having optical power in one axis only) element, elongated perpendicular to the plane of the drawing in the same manner as the light-guide of FIGS. 1A and 1B. As optics for projecting a line of light from a point source or an elongated source of light are well known in the optical art, a detailed description of any such optics is not presented herein. Those skilled in the art will recognize, without further description or illustration that collecting and focusing optics may be used in conjunction with a light-guide without departing from the spirit and scope of the present invention

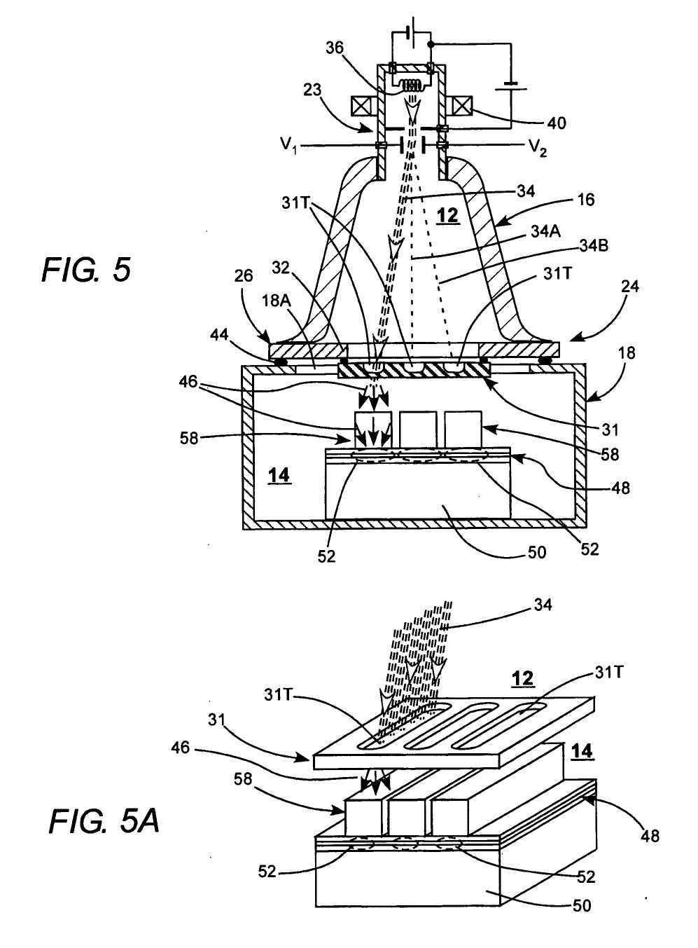

FIGS. 5 and 5A schematically illustrate still yet another embodiment 10C of an optically pumped, edge-emitting semiconductor laser in accordance with the present invention in which the heterostructure is distanced from the UV radiation volume. Laser 10C is similar to laser 10A of FIGS. 2A and 2B with exceptions as follows. Ceramic plate 28 of laser 10A is replaced in laser 10C with a ceramic plate 31 that includes three parallel, elongated grooves 31T providing three parallel electron-transparent foils or membranes. Electron beam gun 20 of laser 10A is replaced with an electron beam gun 23 including spaced-apart deflector plates 64 which deflect elongated e-beam 34 according to voltages V₁ and V₂ applied thereto, in a manner in which an e-beam is raster-scanned in a CRT. The description of electrostatic deflectors, here, is merely exemplary. Magnetic deflection may be used without departing from the spirit and scope of the present invention.

Electron beam gun 23 is operated in pulsed manner, with e-beam 34 deflected to a different membrane after each pulse, as indicated in FIG. 5 by short-dashed lines 34A and 34B. In this arrangement, e-beam 34 can be periodically repositioned, for example at intervals between about 10.0 nanoseconds (ns) and 100.0 microseconds (μs), to provide, in effect, a plurality of individual laser stripes in heterostructure 48 (similar to the stripes of a conventional diode-laser bar) each delivering laser radiation 52. This rapid repositioning of beam 34, in conjunction with effective heat sinking, can minimize heat build up in any particular area of the heterostructure.

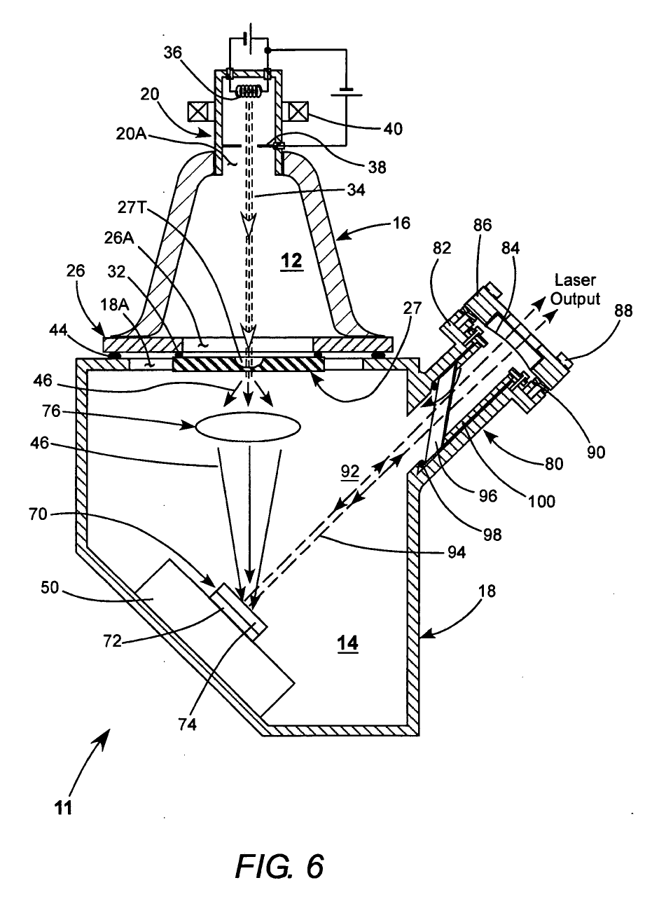

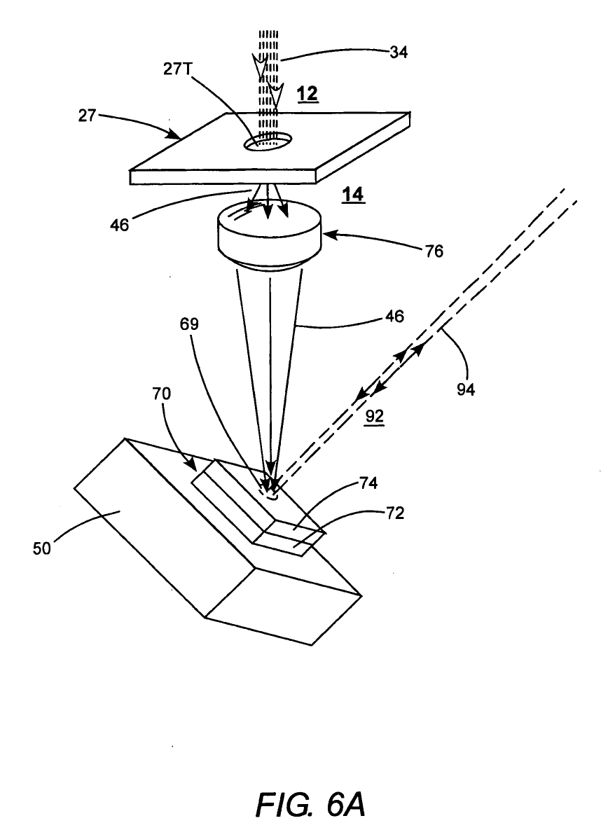

All of the above discussed embodiments of the inventive optically pumped semiconductor laser are directed to optically pumping an edge-emitting heterostructure. FIG. 6 and FIG. 6A, however schematically depicts an embodiment 11 of an optically pumped, surface-emitting semiconductor laser in accordance with the present invention in which a surface-emitting heterostructure 70 is optically pumped. A surface-emitting heterostructure typically includes a mirror-structure 72 surmounted by a gain-structure. The mirror-structure can be made from semiconductor, dielectric or metal layers. The gain-structure usually includes a plurality of quantum-well layers, or groups of quantum-well layers, spaced apart by spacer layers, with the spacing being (optically) one half wavelength (or multiples thereof) at the emission (lasing) wavelength. There are usually between about twelve and fifteen of these half-wave-spaced quantum-wells or groups thereof. At least the quantum-well layers must absorb the UV radiation 46 to allow the structure to be optically pumped by the UV radiation.

While the gain-structure is usually epitaxially grown on a single-crystal substrate, the mirror-structure need not be epitaxially grown, and can be deposited on an epitaxially grown gain-structure in a separate growth or deposition. After the mirror-structure is deposited, the completed surface-emitting heterostructure can be separated from the epitaxial-growth substrate, for example by etching away the substrate, and bonded to heat sink 50.

A preferred mirror-structure for mirror-structure 72 would be an all-dielectric multilayer structure or a structure including a layer of aluminium surmounted by a few dielectric layers for enhancing the reflectivity of the aluminium. Materials suitable for the gain-structure are those discussed above for edge-emitting heterostructures. As many features of laser 11 are common with laser 10C of FIG. 4, a description of only the differences (other than the heterostructure) between the two lasers is set forth below.

In laser 11, electron lens arrangements of e-gun 20 are preferably arranged to provide an e-beam 34 that is essentially circular in cross-section. Correspondingly, ceramic plate 28 of laser 10B is replaced with a ceramic plate 29 having a thinned area 29T providing an electron-transparent ceramic membrane or foil 29T that is about circular and preferably has a diameter between about 1 mm and 3 mm. This provides that the volume in enclosure 14 emitting UV radiation 46 will be about spherical. Correspondingly, collecting and focusing optics 62 of laser 10B are replaced in laser 11 by collecting and focusing optics 76 that are preferably arranged to focus UV radiation to a more-or-less circular spot 69 (see FIG. 6A) on gain-structure 74 of heterostructure 70. Heterostructure 70 is supported on a heat sink 50, and the plane of heterostructure is inclined at about 45° to general propagation direction of UV radiation 46 incident thereon.

Vessel 18 is shaped here to accommodate the 45° inclination of the heterostructure. Vessel 18 also includes a cylindrical extension 80 inclined at about 45° thereto. At the distal end of the extension is a flange 82. A mirror 84 is held in mirror holder 86 which is clamped by screws 88 to flange 82. Springs 90 between the mirror holder and the flange allow the mirror to be aligned by adjusting the screws. Mirror 84 and mirror-structure 72 of the surface-emitting heterostructure form a laser resonator 92. Laser radiation circulates in the laser resonator as indicated by long-dashed lines 94. Mirror 84 is partially transparent and serves to deliver laser radiation out of the resonator.

Within cylindrical extension 80 of vessel 18 a window 96 is clamped against a metal seal 98, via a sleeve 100 within the extension, to make the enclosure 14 gas-tight. Window 96 in this example is at the Brewster angle to the general direction of circulating radiation. This plane-polarizes the circulating laser radiation, which then suffers minimal reflection losses at the window. The window may be replaced by a birefringent filter for selecting a lasing wavelength within the gain bandwidth of gain-structure 74 of surface-emitting heterostructure 70. As is known, separating the output coupler from the gain structure in a surface emitting semiconductor laser permits insertion of various optical elements in the cavity such as filters, etalons and non-linear crystals.

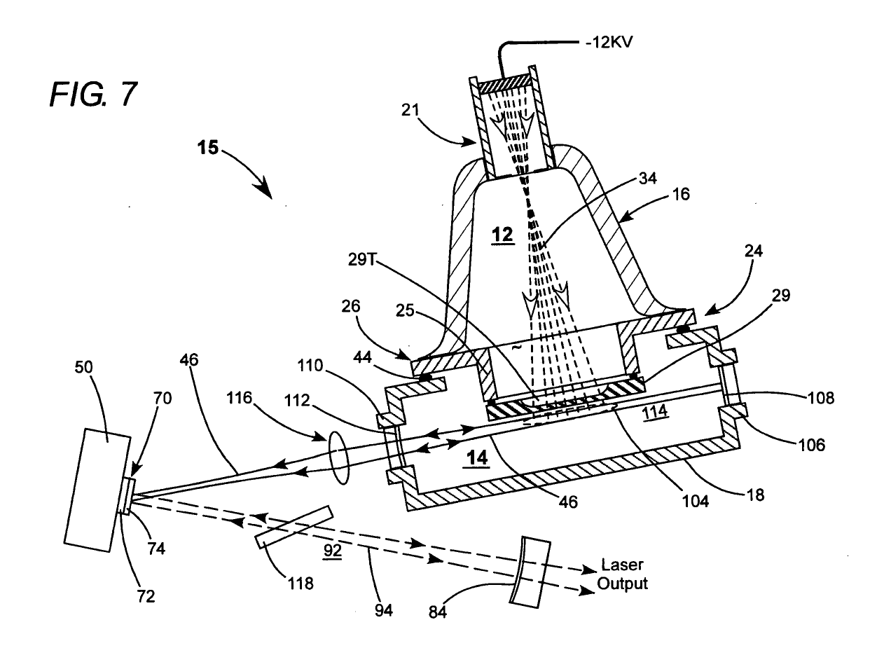

Another embodiment 15 of an optically pumped, surface-emitting semiconductor laser in accordance with the present invention is schematically depicted in FIG. 7. Here again, as many features of laser 15 are common with features of laser 11 of FIG. 6 only important differences are described below. In laser 15, the hot-cathode (thermionic filament) e-gun 20 of above-described embodiments of the inventive laser is replaced with a high voltage, carbon nonotube, field emission type e-gun 21. Electron lensing (not depicted in detail in FIG. 7) in e-gun 21 is arranged such that electron beam 34 is a narrow elongated beam, elongated, here, in the plane of the drawing. E-gun 21 is preferably operated in a pulsed mode, with pulse lengths preferably about 1.0 μs or less. Here, it should be noted that the use of a field emission type e-gun is possible in other above-described embodiments of the present invention.

Ceramic plate 27 of laser 11 is replaced with a ceramic plate 29 having an elongated groove therein forming an elongated membrane 29T corresponding to the elongated e-beam. Membrane 29T preferably has a width of about 1 mm and has a length of about 200 mm. Flange 26 has an extension 25 extending into excimer-forming gas containing vessel 18. Ceramic plate 29 is soldered to this extension. The elongated electron beam is transmitted through membrane 29T and causes excimer-forming interaction with excimer-forming gas in an elongated, narrow volume 104 thereof extending about 1 mm below the membrane.

Vessel 18 has a flange 106 thereon in which is sealed a plane mirror 108, maximally reflective at the characteristic emission wavelength of the excimer. Vessel 18 also has a flange 110, diametrically opposite flange 106, in which is sealed a concave mirror 112, partially reflective and partially transmissive for the emission wavelength of the excimer. As an example, mirror 108 preferably has a reflectivity of about 99.7% or greater and mirror 112 has a reflectivity of about 97%. Mirrors 108 and 112 form a resonator 114. This forces the excimer to emit at a stimulated emission wavelength rather than the spontaneous emission wavelength of previous embodiments. Accordingly, UV radiation 46 is extracted as laser radiation from the resonator via the partially transmitting mirror.

UV radiation 46 delivered from resonator 114 is focused by optics 116 onto gain-structure 74 of surface-emitting heterostructure 70. Mirror 84 and mirror-structure 72 of the surface-emitting heterostructure form a laser resonator 92. Laser radiation circulates in laser resonator 92 as indicated by long-dashed lines 94. Mirror 84 is partially transparent and serves to deliver laser radiation out of the resonator as output radiation. A birefringent filter 118 is included in resonator 92 for selecting a lasing wavelength within the gain bandwidth of gain-structure 74 of surface-emitting heterostructure 70.

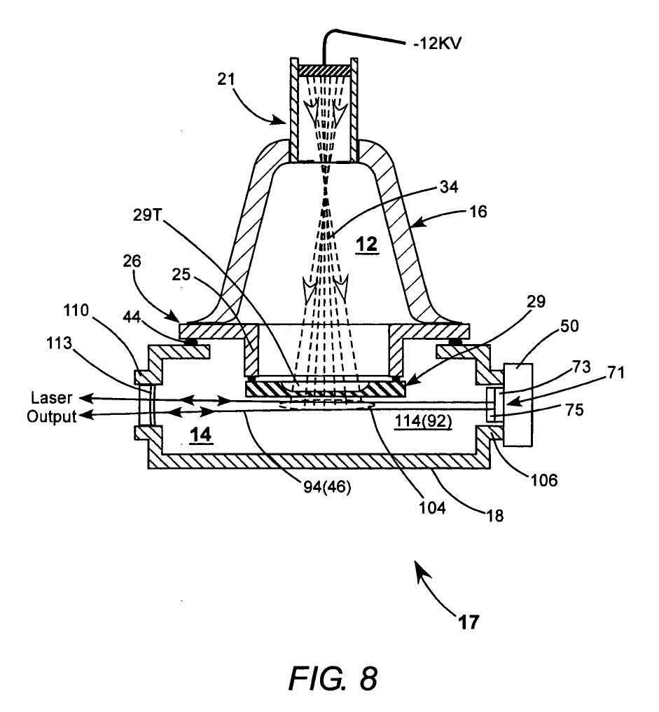

FIG. 8 schematically illustrates yet another embodiment 17 of an optically pumped semiconductor, surface-emitting semiconductor laser in accordance with the present invention. Laser 17 is similar to laser 15 of FIG. 7 with exceptions as follows. Resonators 92 and 114 are both located in excimer-forming gas vessel 18 and are essentially combined into one common resonator for both the UV radiation and the laser radiation (of the heterostructure). The resonators are formed between a mirror-structure 73 of a surface-emitting heterostructure 71 and a concave mirror 113. Heat sink 50 supports the heterostructure and is sealed to flange 106 of vessel 18. Mirror 113 is sealed into flange 410 of vessel 18.

Mirror-structure 73 of the heterostructure is made maximally reflective for both the UV radiation 46 and the laser radiation 94. Mirror 113 is maximally reflective for the UV radiation and partially reflective and partially transmitting for the laser radiation. Surface-emitting gain-structure 75 has only one or two spaced-apart quantum-wells or quantum-well groups, such that only a fraction of the circulating radiation 46 is absorbed in the gain-structure to provide optical pumping. By way of example, consistent with resonator 114 described above, the gain-structure can be arranged such that about 3% of circulating radiation 46 is absorbed, i.e., about the equivalent of that which is delivered from resonator 114 in laser 15 of FIG. 7.

Some advantages of laser 17 are that the laser can be made relatively compact compared with laser 15. Another advantage is that the laser does not require focussing optics for focusing the UV radiation on the gain-structure. Yet another advantage is that the modes of the circulating UV radiation and laser radiation remain precisely matched and aligned on the surface-emitting gain-structure with operational variations in the resonator. One disadvantage of laser 17 is that, because of a requirement for highly wavelength-selective coatings for mirror 113, and broad bandwidth coatings for mirror-structure 73, the laser is only suitable for excimer emission-wavelengths longer than about 300 nm, for which such coatings can be made with low losses. Another disadvantage is that the gain of the resonator for the output laser-wavelength is relatively low, because of the relatively low absorption of the UV radiation in the gain-structure.

In summary the present invention is described above in terms of a preferred and other embodiments. The invention is not limited, however, to the embodiments described and depicted. Rather, the invention is limited only by the claims appended hereto.

What is claimed is:

1. A laser comprising:
first and second enclosures having an electron-permeable membrane therebetween, said first enclosure being under vacuum, and said second enclosure containing an excimer-forming gas;
an electron gun located in said first enclosure an arranged to generate an electron beam and direct said electron beam through said membrane into said excimer-forming gas thereby generating optical radiation; and
a semiconductor heterostructure arranged to be optically pumped by said optical radiation.

2. The laser of claim 1, wherein said semiconductor heterostructure is located within said second enclosure.

3. The laser of claim 1, wherein said semiconductor heterostructure is located outside of said second enclosure.

4. The laser of claim 1, wherein said semiconductor heterostructure is an edge-emitting heterostructure.

5. The laser of claim 1, wherein said heterostructure is a surface-emitting heterostructure.

6. The laser of claim 5, wherein said surface-emitting heterostructure includes a mirror-structure and a gain-structure and the laser further includes a mirror spaced apart from said heterostructure such that said mirror and said mirror-structure form a laser-resonator with said gain-structure being located in said laser resonator.

7. The laser of claim 1, wherein said excimer-forming gas includes one or more of a group of elements consisting of hydrogen, nitrogen, helium, neon, argon, krypton, xenon, fluorine, chlorine, bromine, and iodine.

8. The laser of claim 1, wherein said optical radiation has a wavelength less than about 400 nanometers.

9. The laser of claim 8, wherein said optical radiation has a wavelength between about 60 nanometers and 353 nanometers.

10. The laser of claim 1, wherein materials of said semiconductor heterostructure have a bandgap of about 3 electron-Volts or greater.

11. The laser of claim 10, wherein said heterostructure includes a material selected from a group of materials consisting of II-VI semiconductor materials, metal oxides, metal nitrides, and diamond.

12. The laser of claim 1, wherein said second enclosure includes a first laser-resonator, said optical radiation is generated as laser radiation is generated in said first laser resonator, and said laser radiation is delivered to said semiconductor heterostructure for optically pumping said heterostructure.

13. The laser of claim 12, wherein said semiconductor heterostructure is a surface-emitting heterostructure located outside of said second enclosure.

14. The laser of claim 13, wherein said surface-emitting heterostructure includes a mirror-structure and a gain-structure and the laser further includes a mirror spaced apart from said heterostructure such that said mirror and said mirror-structure form a second laser-resonator with said gain-structure being located in said second laser resonator.

15. The laser of claim 12 wherein said semiconductor heterostructure includes a mirror-structure and a gain-structure and the laser further includes a mirror, said mirror and said hetrostructure being arranged such that said mirror-structure and said mirror form a laser resonator with said gain-structure therein, and such that said optical radiation circulates in said laser resonator, thereby optically pumping said heterostructure.

16. The laser of claim 1, wherein there is a plurality of elongated, spaced-apart and parallel electron-transparent membranes between said first and second enclosures and wherein said electron beam gun is arranged such that said electron beam can be selectively directed towards any one of said membranes and delivered therethrough, whereby said heterostructure can be selectively optically pumped at a plurality different spaced-apart positions thereon.

17. The laser of claim 1, wherein there is a lightguide positioned between said membrane and said heterostructure and arranged to guide said optical radiation to said heterostructure.

18. The laser of claim 1, wherein there is at least a focusing element located between said membrane and said heterostructure and arranged to concentrate said optical radiation on said heterostructure.

19. A method of operating a semiconductor laser including a semiconductor heterostructure, comprising:
converting electron energy to optical radiation in an excimer-forming gas; and
optically pumping the semiconductor heterostructure with said optical radiation.

20. The method of claim 19, wherein said converting step includes generating a beam of electrons, and delivering the electrons into the excimer-forming gas.

21. The method of claim 19, wherein said excimer-forming gas includes an element selected from the group of elements consisting of hydrogen, nitrogen, helium, neon, argon, krypton, xenon, fluorine, chlorine, bromine, and iodine.

22. An apparatus comprising:
a source for generating an electron beam;
a chamber having an excimer forming gas located therein, said chamber having an aperture permitting the electron beam to enter the chamber for exciting the gas to generate ultraviolet radiation; and
a gain medium in optical communication with the chamber, said gain medium being optically pumped by the ultraviolet radiation.

23. An apparatus as recited in claim 22, wherein said gain medium is comprised of a semiconductor heterostructure.

24. An apparatus as recited in claim 22, wherein said gain medium is located in an optical resonator and wherein said apparatus generates laser light when the gain medium is pumped by the ultraviolet radiation.
